(19) United States
(12) Patent Application Publication
(10) Pub. No.: US 2022/0134619 A1
(43) Pub. Date: May 5, 2022

(54) INJECTION MOLDING METHOD AND APPARATUS

(71) Applicant: Canplas Industries Ltd., Barrie, ON (US)

(72) Inventor: James Brian Mantyla, Barrie (CA)

(21) Appl. No.: 17/113,658

(22) Filed: Dec. 7, 2020

(30) Foreign Application Priority Data
Nov. 5, 2020 (CA) 3098195

(51) Int. Cl. B29C 45/16; B29C 45/00; B29C 45/26; B29C 45/80

(52) U.S. Cl. CPC B29C 45/1635; B29C 45/0025; B29C 45/26; B29C 2945/76742; B29C 2045/0027; B29C 2945/76568; B29C 2945/76859; B29C 45/80

(57) ABSTRACT

A method of injection molding thick plastic parts, comprising molding a transitional part using by a first shot through the first or A-side of the mold, moving the transitional part and mold core away from the mold cavity to create a second shot space, and injecting a second shot which merges with the transitional part to create a final part.

### CROSS REFERENCE TO RELATED APPLICATION

This application claims the benefit of priority to Canadian Application No. 3098195 filed on Nov. 5, 2020. The entire contents of the aforementioned application are incorporated herein by reference in its entirety.

### FIELD OF THE INVENTION

This invention is directed to the field of manufacturing of plastic parts, and in particular, to the field of injection molding of plastic parts.

### BACKGROUND OF THE INVENTION

Injection molding is a process for manufacturing parts, often plastic parts. It is typically used for manufacturing of high volumes of parts. In a typical case, molten plastic is injected into a mold, whose interior space forms the plastic into the desired shape of the part. After injection of the molten plastic, the mold is cooled, and the plastic solidifies and hardens into the part being manufactured. The part is then ejected from the mold, and the process repeated.

The injection molding of plastic parts that are thick, or have thick portions, can produce certain problems. One problem is the presence of shrinkage voids in the molded part. When the part is cooled, the plastic shrinks, but in thick parts, sometimes the outer skin of the part will be stiff enough to resist shrinkage while the plastic underneath shrinks. In this way, shrinkage voids are created.

Another problem is poor weld or knit line strength around molded holes. Such lines occur when the molten plastic is flowing into an area of the mold from two directions. The meeting line of the two flows can produce weld or knit lines. In thick parts, the part can be weak along the weld line, and may thus not have the resistance to breaking that a good quality part would have.

Another problem is the appearance of sink marks on the thick portions of the parts. Sink marks arise from unequal cooling of the plastic by the walls of the mold, which in turn leads to unequal shrinking of the plastic. This problem can be addressed, for example, by secondary machining of the manufactured parts, but this solution is costly and inconvenient.

Another problem that sometimes arises is burning and degradation of the plastic during molding. One reason for this problem is that, with thick parts, the molding cycle time is long, because a long time is required to have all of the necessary plastic flow to form the thick part, and then still more time is necessary to cool the mold enough for a thick part to harden.

Attempts have been made to deal with one or more of these problems. U.S. Patent Publication Number 2003/0164564 (“Klotz”) discloses a method and apparatus for making thick walled plastic parts, particularly blanks for optical lenses. The method involves delivering molten plastic into a mold to make a thin lens and the thin lens being pre-compressed in the mold. Then, the thin lens is held in place and space in the mold opened up behind the thin lens as molten plastic continues to be delivered into the mold to enlarge the lens to the desired thickness. Then, the enlarged lens is compressed in the mold.

This method suffers from several drawbacks. First, it requires multiple complicated movements of the mold. Next, it requires an unusual structure, in that the gate has to be positioned away from the hot side of the mold. Furthermore, the mold requires unusual shoulder formations to hold the thin lens in place.

U.S. Patent Publication Number 2012/0315441 (“Bald”) discloses an injection molding method for making an annular part having a recess. A mold is used with a central core and a surrounding mold portion to create the annular part. A first shot of molten plastic is used to partly create the annular part with a thinner wall than desired for the end product. Then the central core is withdrawn and a second core with a smaller radius is inserted. Then a second shot is performed to thicken the annular part and produce the final version. One of the drawbacks of this method is the necessity to withdraw a part of the mold and replace with a different mold to finish each part. To manufacture a new part, the cores would need to be switched again. The result is high cost and inconvenience, and slow production.

U.S. Pat. No. 5,882,559 to Eckhardt et al. discloses a process for injection-molding a two-layer part, with one layer being plastic and the other enamel. One nozzle is used to inject plastic, and a second to inject enamel, to form the part. One drawback of this method is the need for two nozzles, which adds expense and complexity to the required molding apparatus.

Other examples of injection molding apparatuses or methods include those disclosed in U.S. Published Patent Applications 2018/0214879, 2018/0207863, 2019/0255750, 2018/0272583, 2015/0290850, 2015/0190953, 2014/0151931, 2012/0308764, 2012/0146260, 2011/0278312, 2006/0237874, 2003/0017325, 2003/0164564 and 2004/0188895; and U.S. Pat. Nos. 4,828,769 and 7,704,423.

### SUMMARY OF THE INVENTION

What is desired is a method of injection molding parts, such plastic parts, that ameliorates one or more of the above-noted problems.

Therefore, according to one aspect of the present invention there is provided a method of injection molding a part using an injection molding machine including a mold having a first side and a second side, the method comprising the steps of:

positioning the first side and the second side at a first distance from one another to provide a first shot space;

injecting a first shot of thermoplastic material via a nozzle through the first side into the first shot space;

allowing the first shot of thermoplastic material to cool and harden into a transitional part;

moving the second side and the transitional part away from the first side to provide a second shot space comprising space between the transitional part and the first side;

injecting a second shot of thermoplastic material via the nozzle into the second shot space such that the second shot of thermoplastic material merges with the transitional part; and

allowing the second short of thermoplastic material to cool and harden into a final part.

Optionally, the first side comprises a mold cavity, and wherein the second side comprises a mold core. Optionally, the first shot space has a first shot space volume that is about 60-85 percent of a total volume of the first shot space and the second shot space. Preferably, the first shot space volume is about 70-80 percent of said total volume. More preferably, the first shot space volume is about 75 percent of said total volume. Optionally, the transitional part is allowed to cool and harden so as to produce sink marks on the transitional part, and the step of injecting a second shot comprises injecting a second shot of thermoplastic material into the second shot space such that the second shot of thermoplastic material merges with the transitional part to even out and remove said sink marks.

According to a further aspect of the present invention, there is also provided an injection molding apparatus comprising:

a computer processor and associated data storage memory, and an injection molding machine having a mold, the mold having a first side and a second side, the injection molding apparatus being configured to:

position the first side and second side at a first distance from one another to provide a first shot space;

inject a first shot of thermoplastic material via a nozzle through the first side into the first shot space;

allow the first shot of thermoplastic material to cool and harden into a transitional part;

move the second side and the transitional part away from the first side to provide a second shot space comprising space between the transitional part and the first side;

inject a second shot of thermoplastic material via the nozzle into the second shot space such that the second shot of thermoplastic material merges with the transitional part; and

allow the second short of thermoplastic material to cool and harden into a final part.

### BRIEF DESCRIPTION OF THE DRAWINGS

Reference will now be made by way of example only to preferred embodiments of the invention by reference to the following drawings in which:

FIG. 1 is a simplified diagram of an example injection molding machine;

FIG. 2 is a perspective view of a plastic injection molded pipe flange;

FIG. 3 is a simplified cutaway view of a mold with thermoplastic material therein;

FIG. 4 is a second simplified cutaway view of a mold with thermoplastic material therein; and

FIG. 5 is a schematic representation of an injection molding apparatus.

### DETAILED DESCRIPTION OF THE PREFERRED EMBODIMENTS

In this detailed description, the method of injection molding a part, and related apparatus, will be described with reference to injection molding of plastic flanges, such as pipe flanges. However, it will be appreciated that the invention is not limited to this particular part, or to any particular part. Rather, the invention may be applied in any appropriate situation to ameliorate one or more of the problems discussed above.

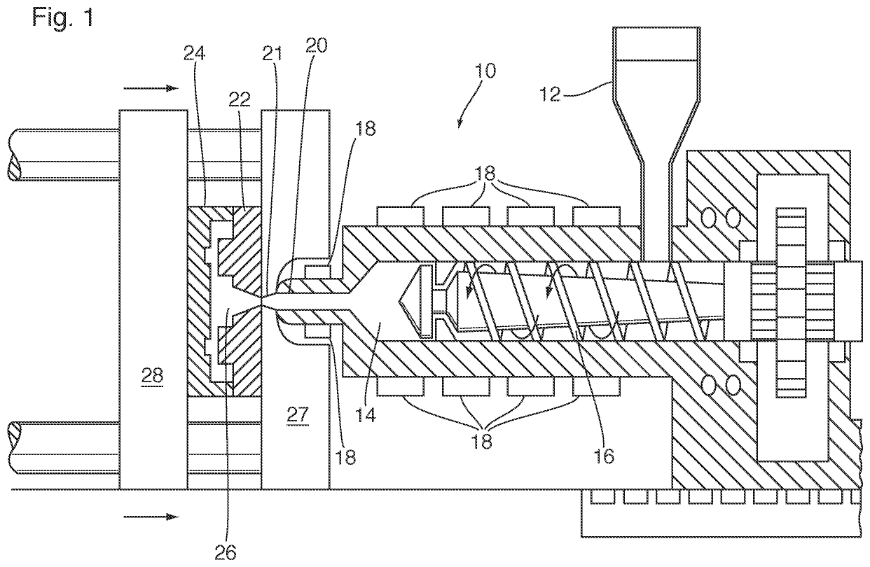

Referring now to FIG. 1, a schematic diagram of a non-limiting example of an injection molding machine 10 is shown. Machine 10 is, in this embodiment, a single-nozzle injection molding machine. A feeder hopper 12 is shown. Feeder hopper 12 contains the plastic to be molded, and the plastic is typically in the form of pellets. The hopper feeds screw conduit 14, containing conveyor screw 16. Screw 16 conveys the plastic along the conduit toward the mold.

Heating elements 18 are positioned adjacent to conduit 14, and typically surround conduit 14 so as to heat and melt the plastic. The melting puts the plastic into a liquid phase so that it can flow into the mold. As the plastic melts it continues to be conveyed by screw 16 toward the mold.

The plastic continues along conduit 14 and through nozzle 20 and sprue bushing 21 into the mold. The mold, in this example, consists of the mold cavity 22 and mold core 24, which, when positioned together, define mold space 26 in which the part is formed. Mold cavity 22 is typically stationary and mounted, for example, on fixed plate 27, while mold core 24 is, for example, movable and mounted on moving plate 28. Moving plate 28 may carry an ejection actuator (not shown) with control ejector pins (not shown) to eject the molded part.

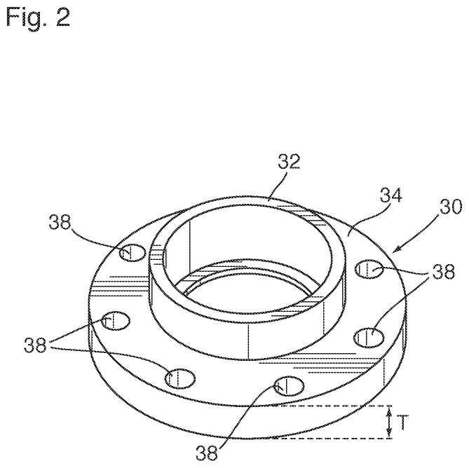

Referring now to FIG. 2, a part, which in this example is pipe flange 30, is shown. This example pipe flange has a pipe fitting 32 for receiving a pipe and a mounting flange 34 for mounting pipe flange 30. Mounting flange 34 has thickness T, which is substantial, to provide effective support of piping and effective mounting of part 30 while reducing the risk of cracking or breaking in use. Positioned on mounting flange 34 are mounting holes 38 for mounting pipe flange 30 using, for example, mounting bolts (not shown).

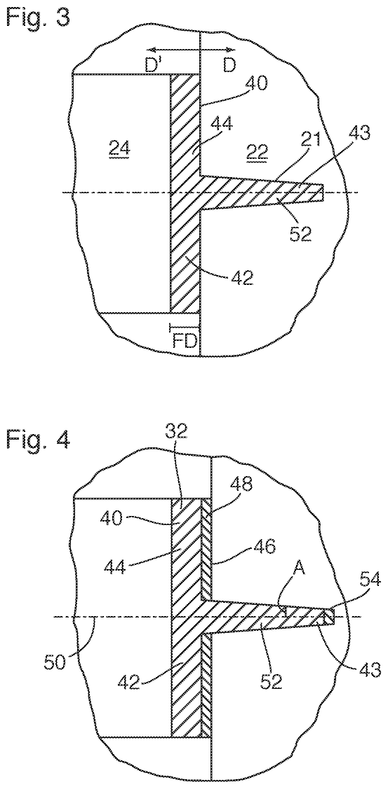

Referring now to FIG. 3, a cutaway simplified drawing of the mold is shown. The first side of the mold, comprising, in this example, mold cavity 22, is shown. Mold cavity 22 operates in concert with the second side of the mold, which in this example comprises mold core 24. In the preferred embodiment, mold core 24 moves in toward mold cavity 22 in direction D, and out in direction D′.

In the preferred embodiment, the mold cavity 22 and mold core 24 are positioned a first distance FD from one another so as to provide a first shot space 40 for receiving a first shot 42 of thermoplastic material. The first shot 42 of thermoplastic material is then injected via nozzle 20 through mold cavity 22 into first shot space 40. The first shot 42 of thermoplastic material is then allowed to cool and harden into a transitional part 44. Commonly, transitional part 44 will include transitional part sprue 52 formed from the first shot 42. It will be appreciated that the part is being molded using two shots of thermoplastic material, and thus, in two steps. Thus, the transitional part 44 is the part in existence after the first shot 42 cools and hardens, prior to the next shot.

Next, in the preferred embodiment, the mold core 24 and transitional part 44 (including sprue 52) are moved in direction D′ to create a second shot space 46. The second shot space 46 comprises space between the transitional part 44 and the mold cavity 22, for receiving a second shot 48 of thermoplastic material. The movement in direction D′ also creates gap or space 47 between transitional part sprue 52 and sprue bushing 21. The second shot 48 of thermoplastic material is then injected via nozzle 20 and gap 47 into the second shot space 46 such that it merges with the transitional part 44. This in turn results in the formation of an integral final part (in this example, pipe flange 30) once the second shot 48 of thermoplastic material is allowed to cool and harden. The final part may then be ejected.

As the second shot 48 enters the second shot space 46, the thermoplastic material is melted and hot. Therefore, as it contacts the transitional part 44, the corresponding surface of the transitional part 44 will melt from contact with the hot second shot plastic, thus merging the second shot plastic with the transitional part. Then the melted plastic will cool and harden, resulting in the final part being formed.

It will be appreciated that this method is likely to ameliorate one or more of the problems associated with injection molding thick plastic parts. For example, sink marks resulting from uneven cooling are less likely to occur, because the plastic being cooled is relatively thin. First, the first shot 42 (thinner than final part 30) is cooled, and next, the second shot 48 (also thinner than the final part) is cooled. Thus, under this method, the full thickness of the part is not cooled in a single cooling step. The likelihood of sink marks increases when the thickness of the part being cooled increases. This method reduces the thickness of plastic being cooled at any one time. For similar reasons, reduced incidence of weak weld/knit lines, and reduced incidence of shrinkage voids, can be expected when the preferred embodiment of the method is carried out.

Furthermore, it is believed that using this method will permit lower cycle time for molding the final parts, even though this method involves two molding steps rather than just one. The reason is that as the thickness of the part increases, the time required with the molten plastic under compression increases disproportionately greatly, precisely because longer compression and cooling times are employed to reduce problems such as shrink marks and shrinkage voids. However, because in the preferred embodiment the thickness of each shot is substantially smaller than the thickness of the final part, the compression and cooling times can be reduced substantially, so that the overall cycle time for molding the final part is reduced as compared with a single shot. In turn, it is believed that the reduction in cycle time will lead to fewer incidences of burning and degradation of the plastic during molding.

It will be appreciated by those skilled in the art that commonly, to mold ordinary parts, manufacturers employ conventional single-shot molding machines with single shot molds in which the molten plastic is injected through the mold cavity 22 into the mold. They may have a need to mold parts with areas of significant thickness, and would prefer to use their existing conventional injection presses. For example, the volume of production of thick parts may not justify new tooling or major changes to the molding machines, or the use of expensive two-shot molds and molding machines, and even if they did, it would be preferable to avoid the expense of new molding machines or new tooling.

In the past, a manufacturer wanting to use conventional single shot injection presses might have used a first injection press to mold the first shot, manually remove the transitional part, and place it in a second injection press to mold the second shot. However, this option is costly in terms of labor, molding machine cycle time and usage.

The preferred embodiment of the present method can permit use of these conventional molding machines without the costs of major changes to or replacement of molding machines, and without much, if any, new tooling. Excess labour and press time costs can also be avoided. The same basic structure of machine, with a single injection nozzle injecting through the mold cavity, can generally be used with the preferred embodiment of the method. Such machines already have the capacity to move the mold core in and out of the mold cavity, and the precise positioning of the mold core during molding and ejection of the part is generally, in modern machines, electronically controlled for precision.

In the most preferred embodiment, in molding a thick part such as, for example, pipe flange 30, the first shot space volume will comprise about seventy-five percent, and the second shot space volume about twenty-five percent, of the total volume of the two shot spaces. This approach is preferred because most of the shrinkage occurring during the molding process would happen to the first shot 42 of thermoplastic material, because the first shot 42 is substantially thicker than the second shot 48. In the event that there is, for example, uneven shrinkage resulting in shrink marks on transitional part 44, the second shot 48 would merge with the transitional part to even out the unevenness and thus eliminate or remove the shrink marks. Because the second shot space 46, and thus the second shot 48, are relatively thin, they will suffer relatively little shrinkage, more even cooling, and thus are at substantially lower risk of shrink marks. Thus, even if the surface of the transitional part 44 is uneven, thermoplastic material from the second shot 48 will fill in depressions or other marks caused by the shrinkage of the material in the transitional part 44.

It is comprehended by the preferred embodiment that the volume of the first shot space be between 60 and 85 percent of the total volume of the first and second shot spaces. It is more preferred that this range be 70-80 percent, and most preferred that the first shot space volume be about 75 percent. It will be appreciated that if the first shot is not sufficiently thick, then there may not be much reduction in the shrinkage of the second shot as compared with the first. If the first shot is too thick and the second shot too thin, then there may be too much uneven shrinkage in the first shot and not enough material in the second shot to even out the transition part.

In the preferred two-shot process described herein, the angle A of sprue bushing 21 will be greater, relative to the central axis 50 of the sprue bushing, than it would be in a single-shot process. As shown in FIG. 2, the first shot may result in a transitional sprue 52 on transitional part 44. Then, after transitional part 44 moves back, sprue 52 extends into the space within sprue bushing 21. The second shot 48 of thermoplastic material then enters the mold space, and in particular, second shot space 46, travelling around the outside of sprue 52 to get there. If angle A is too small, then there may be too little space for second shot 48 of thermoplastic to flow around sprue 52 to reach second shot space 46. By increasing angle A, there is more room for second shot 48 to flow directly and easily to second shot space 46.

In additional, it will be appreciated that in the present method, it is important for the transitional part 44 to move away from mold cavity 22 after the first shot. If angle A is too narrow, the transitional part may be liable to stick on mold cavity 22, which is undesirable and would require interruption of the molding process while the transitional part is removed. Also, it is generally desirable for the final part to move off of the mold cavity, and move with the mold core, after the second shot, because, typically, the ejection actuator is associated with the mold core and is configured to eject the final part from the mold core. Thus, preferably, angle A should be large enough for the final part to move off of the mold cavity and stick on the mold core after the second shot.

In the example of the method described here, the final part (in this case, ring 32) would have a final part sprue 54, just as the same final part might have a sprue if molded with a single shot. It will be appreciated that this sprue may be dealt with by, for example, cutting the sprue off using another machine, or by whatever method sprues are typically dealt with.

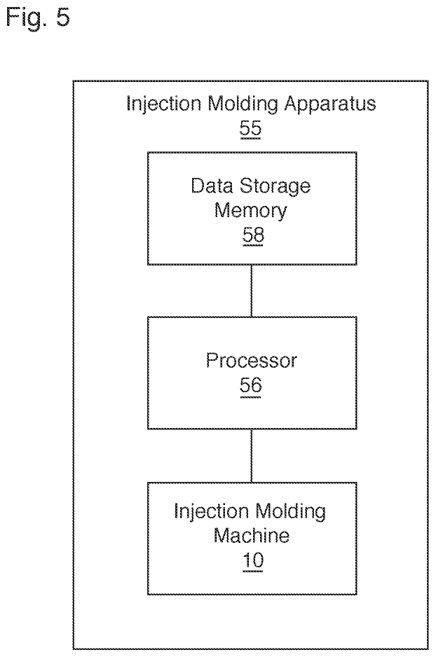

Referring now to FIG. 5, in one embodiment, an injection molding apparatus 55 may comprise a computer processor 56 and associated data storage memory 58. The processor 56 may be operatively connected to the injection molding machine 10. The processor 56 may execute software instructions in the form of computer readable program code (which may be stored in the associated memory 58, and which may be non-transitory) to cause the injection molding machine 10 to carry out the method described herein. The memory 58 comprises a computer readable storage medium or media. Processor 56 may comprise one or more digital processors or computers. The software may be implemented or written in Java, C++ or other suitable form.

While reference has been made to various preferred embodiments of the present invention the scope of the invention is only limited by the enclosed claims. Various alterations have been described above and are comprehended by the claims attached.

1. A method of injection molding a part using an injection molding machine including a mold having a first side and a second side, the method comprising the steps of:
positioning the first side and the second side at a first distance from one another to provide a first shot space;
injecting a first shot of thermoplastic material via a nozzle through the first side into the first shot space;
allowing the first shot of thermoplastic material to cool and harden into a transitional part;
moving the second side and the transitional part away from the first side to provide a second shot space comprising space between the transitional part and the first side;
injecting a second shot of thermoplastic material via the nozzle into the second shot space such that the second shot of thermoplastic material merges with the transitional part; and
allowing the second short of thermoplastic material to cool and harden into a final part.

2. A method as claimed in claim 1, wherein the first side comprises a mold cavity, and wherein the second side comprises a mold core.

3. A method as claimed in claim 1, wherein the first shot space has a first shot space volume that is about 60-85 percent of a total volume of the first shot space and the second shot space.

4. A method as claimed in claim 3, wherein the first shot space volume is about 70-80 percent of said total volume.

5. A method as claimed in claim 3, wherein the first shot space volume is about 75 percent of said total volume.

6. A method as claimed in claim 1, wherein the final part comprises a pipe flange.

7. A method as claimed in claim 1, wherein the transitional part is allowed to cool and harden so as to produce sink marks on the transitional part, and wherein said step of injecting a second shot comprises injecting a second shot of thermoplastic material into the second shot space such that the second shot of thermoplastic material merges with the transitional part so as to even out and remove said sink marks.

8. A method as claimed in claim 1, the method further comprising the step of ejecting the final part.

9. An injection molding apparatus comprising:
a computer processor and associated data storage memory, and an injection molding machine having a mold, the mold having a first side and a second side, the injection molding apparatus being configured to:
position the first side and second side at a first distance from one another to provide a first shot space;
inject a first shot of thermoplastic material via a nozzle through the first side into the first shot space;
allow the first shot of thermoplastic material to cool and harden into a transitional part;
move the second side and the transitional part away from the first side to provide a second shot space comprising space between the transitional part and the first side;
inject a second shot of thermoplastic material via the nozzle into the second shot space such that the second shot of thermoplastic material merges with the transitional part; and
allow the second short of thermoplastic material to cool and harden into a final part.

10. An injection molding apparatus as claimed in claim 9, wherein the first shot space has a first shot space volume that is about 60-85 percent of a total volume of the first shot space and the second shot space.

11. An injection molding apparatus as claimed in claim 9, wherein the first shot space volume is about 70-80 percent of said total volume.

12. An injection molding apparatus as claimed in claim 9, wherein the first shot space volume is about 75 percent of said total volume.

13. An injection molding apparatus as claimed in claim 9, wherein the transitional part is allowed to cool and harden so as to produce sink marks on the transitional part, and wherein said step of injecting a second shot comprises injecting a second shot of thermoplastic material into the second shot space such that the second shot of thermoplastic material merges with the transitional part so as to even out and remove said sink marks.

14. A non-transitory computer readable medium or media having computer readable program code embodied therein, said computer readable program code being adapted to be executed by one or more computer processors to cause an injection molding machine, that includes a mold having a first side comprising a mold cavity and a second side comprising a mold core, to execute the method of claim 1.

15. A non-transitory computer readable medium or media having computer readable program code embodied therein, said computer readable program code being adapted to be executed by one or more computer processors to cause an injection molding machine, that includes a mold having a first side comprising a mold cavity and a second side comprising a mold core, to execute the method of claim 3.

16. A non-transitory computer readable medium or media having computer readable program code embodied therein, said computer readable program code being adapted to be executed by one or more computer processors to cause an injection molding machine, that includes a mold having a first side comprising a mold cavity and a second side comprising a mold core, to execute the method of claim 4.

17. A non-transitory computer readable medium or media having computer readable program code embodied therein, said computer readable program code being adapted to be executed by one or more computer processors to cause an injection molding machine, that includes a mold having a first side comprising a mold cavity and a second side comprising a mold core, to execute the method of claim 5.

18. A non-transitory computer readable medium or media having computer readable program code embodied therein, said computer readable program code being adapted to be executed by one or more computer processors to cause an injection molding machine, that includes a mold having a first side comprising a mold cavity and a second side comprising a mold core, to execute the method of claim 6.

19. A non-transitory computer readable medium or media having computer readable program code embodied therein, said computer readable program code being adapted to be executed by one or more computer processors to cause an injection molding machine, that includes a mold having a first side comprising a mold cavity and a second side comprising a mold core, to execute the method of claim 7.
